(19) United States
(12) Patent Application Publication
(10) Pub. No.: US 2010/0302800 A1
(43) Pub. Date: Dec. 2, 2010

(54) Back light module and light guide plate thereof

(75) Inventors: Lei-Ming YANG, Hsin-Chu (TW); Tun-Chien TENG, Hsin-Chu (TW); Kuo-Tung TIAO, Hsin-Chu (TW)

Correspondence Address: BACON & THOMAS, PLLC, 625 SLATERS LANE, FOURTH FLOOR, ALEXANDRIA, VA, 22314-1176, US

(73) Assignee: CORETRONIC CORPORATION, Hsin-Chu (TW)

(21) Appl. No.: 12/662,698

(22) Filed: Apr. 29, 2010

(30) Foreign Application Priority Data
May 27, 2009 (TW) 098117612

(51) Int. Cl. F21V 7/04

(52) U.S. Cl. 362/606; 362/613

(57) ABSTRACT

A light guide plate adapted to a backlight module is provided. The backlight module has a plurality of point light sources providing a light beam of a predetermined wavelength. The light guide plate includes a light emitting surface, a bottom opposite to the light emitting surface, a light incident surface connecting the light emitting surface and the bottom, a plurality of grating structures, and a plurality of diffusion dots. The light incident surface is near the point light sources. The diffusion dots are disposed on the bottom. At least portions of the grating structures are disposed on the light incident surface. Each of the grating structures has a plurality of concave parts and a plurality of protruding parts. Each of the concave parts is disposed between two neighboring protruding parts. A ratio of the predetermined wavelength to a pitch between two neighboring protruding parts is ranged between 1.2 to 1.3.

### BACKGROUND OF THE INVENTION

(1) Field of the Invention

This invention relates to a backlight module and a light guide plate thereof, and more particularly relates to a light guide plate with grating structures.

(2) Description of the Prior Art

In recent years, light emitting diodes (LED) are widely used as the light source of a backlight module in the LCD. Thus, the application of LEDs in the LCD industry becomes more important in contrast with the other light sources, such as CCFL. As shown in FIG. 1, the backlight module 100 includes a plurality of point light sources 110, such as the LEDs, and a light guide plate 120. The point light sources 110 are disposed on a light incident surface 121 of the light guide plate 120.

The backlight module 100 using LEDs as the light sources has the advantages of low power consumption, environment benefit and low price. However, for the LED is a point light source 110, providing light beams in a large divergence angle θ about 120 degrees or more, a triangle dark area 130 is formed in the light guide plate 120 encircled by the light beams L emitted from the two neighboring point light sources 110. Thus, the distribution of light intensity on the light incident surface 121 of the light guide plate 120 is uneven, and the brightness distribution of the emitted light from the light guide plate 120 is influenced.

In view of the aforementioned disadvantages of the conventional technology, a practical and effective solution is needed for the present technology.

### SUMMARY OF THE INVENTION

The invention provides a light guide plate with grating structures to enhance the efficiency of the light guide plate.

A light guide plate adapted to a backlight module is provided in accordance with an embodiment of the invention. The backlight module has a plurality of point light sources providing light beams of a predetermined wavelength. The light guide plate includes a bottom, a light emitting surface, a light incident surface, a plurality of grating structures, and a plurality of diffusion dots. The light emitting surface is located opposite to the bottom. The light incident surface is connected with the light emitting surface and the bottom, and is near the point light sources. Each of the grating structures has a plurality of concave parts and a plurality of protruding parts. Each of the concave parts is disposed between the two neighboring protruding parts. A ratio of the predetermined wavelength to a pitch between the two neighboring protruding parts is ranged between 1.2 to 1.3. A portion of the grating structures are disposed on the light emitting surface. The diffusion dots are disposed on the bottom.

According to an embodiment of the invention, the grating structure is disposed on the bottom of the light guide plate.

A backlight module is also provided in accordance with an embodiment of the invention. The backlight module includes a plurality of point light sources, the above mentioned light guide plate, a reflector, and a plurality of optical films. The light incident surface of the light guide plate is near the point light sources. The grating structures are disposed on the bottom and the light emitting surface. The diffusion dots are disposed on the bottom. The reflector is disposed on the bottom of the light guide plate. The optical films are disposed on the light emitting surface of the light guide plate.

According to an embodiment of the invention, a cross-section of the concave part and the protruding part shows an arc-shape.

According to an embodiment of the invention, the grating structure is one of a transparent grating structure and a reflective grating structure.

According to an embodiment of the invention, the diffusion dots are disposed adjacent to the light incident surface and are located between the point light sources.

According to an embodiment of the invention, the optical films includes a diffusion plate and a brightness enhancement film.

The light guide plate in accordance with the invention features the grating structures to control the directions of the light beams to have the light beams transmitted to the triangle dark area of the light guide plate so as to compensate the illumination from the dark area to enhance the using efficiency of light beams emitting from the light guide plate.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention and are incorporated in and constitute a part of this specification. The drawings illustrate embodiments of the invention and, together with the description, serve to explain the principles of the invention.

FIG. 1 is a schematic view showing a conventional light guide plate adapted to a backlight module.

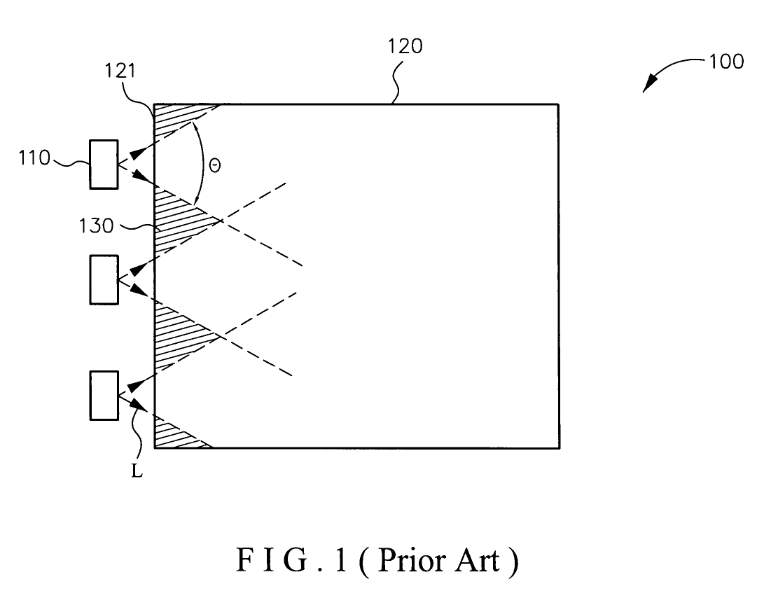

FIG. 2 is a schematic view showing a light guide plate adapted to the backlight module in accordance with an embodiment of the invention.

FIG. 3 is a schematic view of the light guide plate in accordance with an embodiment of the invention.

FIG. 4 is a cross-sectional view of the grating structure along A-A′ in FIG. 3.

FIG. 4a is a cross-sectional view of the grating structure in accordance with an embodiment of the invention.

FIG. 5 is a schematic view showing the light path of the light beam entering the grating structure.

FIG. 6 is a side view of the light guide plate in accordance with an embodiment of the invention.

FIG. 7 is a diagram showing the relationship between the incident angle and the diffraction angle.

FIG. 8 is a diagram showing the relationship between the energy of the diffraction light beams and the diffraction angle of the diffraction light beams.

### DESCRIPTION OF THE PREFERRED EMBODIMENTS

In the following detailed description of the preferred embodiments, reference is made to the accompanying drawings which form a part hereof, and in which is shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component facing “B” component directly or one or more additional components is between “A” component and “B” component. Also, the description of “A” component “adjacent to” “B” component herein may contain the situations that “A” component is directly “adjacent to” “B” component or one or more additional components is between “A” component and “B” component. Accordingly, the drawings and descriptions will be regarded as illustrative in nature and not as restrictive.

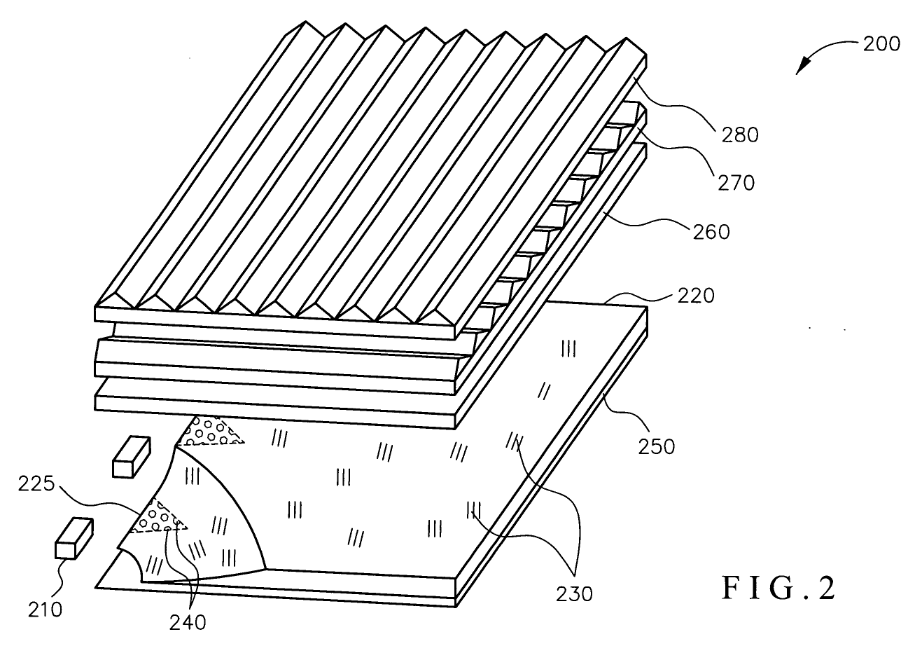

Please refer to FIG. 2, the light guide plate 220 is adapted to the backlight module 200. The backlight module 200 includes a plurality of point light sources 210, the light guide plate 220, a reflector 250, and a plurality of optical films. Each of the point light sources 210 is utilized to emit a light beam. A triangle dark area 225 is formed between light beams emitted by the two neighboring point light sources 210.

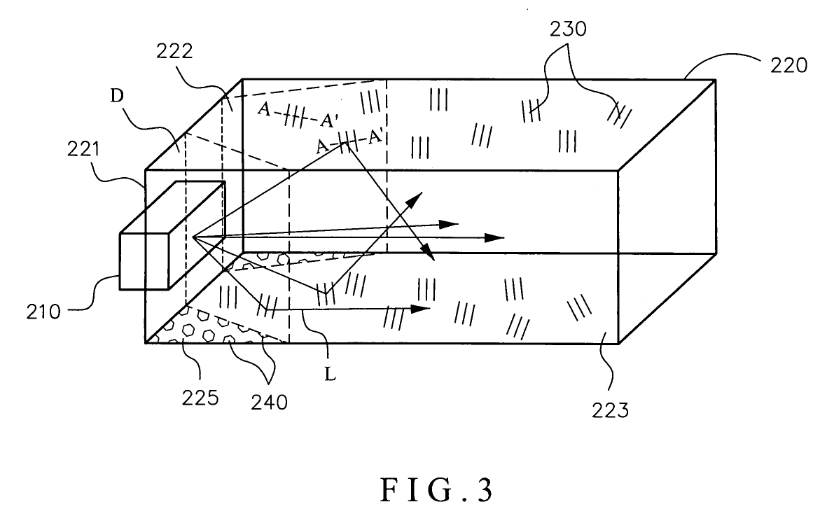

As shown in FIG. 3, the light guide plate 220 includes a light emitting surface 222, a bottom 223 opposite to the light emitting surface 222, a light incident surface 221 connected with the light emitting surface 222 and the bottom 223, a plurality of grating structures 230, and a plurality of diffusion dots 240. The light incident surface 221 located between the light emitting surface 222 and the bottom 223, is near the point light sources 210 and is utilized to receive the light beams L emitted by the point light sources 210. The light beams L entering the light guide plate 220 through the light incident surface 221 are emitted from the light emitting surface 222.

In the embodiment, the grating structures 230 are disposed on the light emitting surface 222 and the bottom 223. However, the invention is not so limited. The grating structures 230 may be disposed on the light emitting surface 222 or the bottom 223. In addition, the direction of the grating structures 230, as indicated by the unparallel dashed line A-A′, may be randomly distributed. After the light beams entering the light guide plate 220 from the light incident surface 221, the light beams L are incident to the grating structures 230, the traveling direction of the light beams L are controlled by the grating structure 230 due to the optical dispersion character of the grating structures 230.

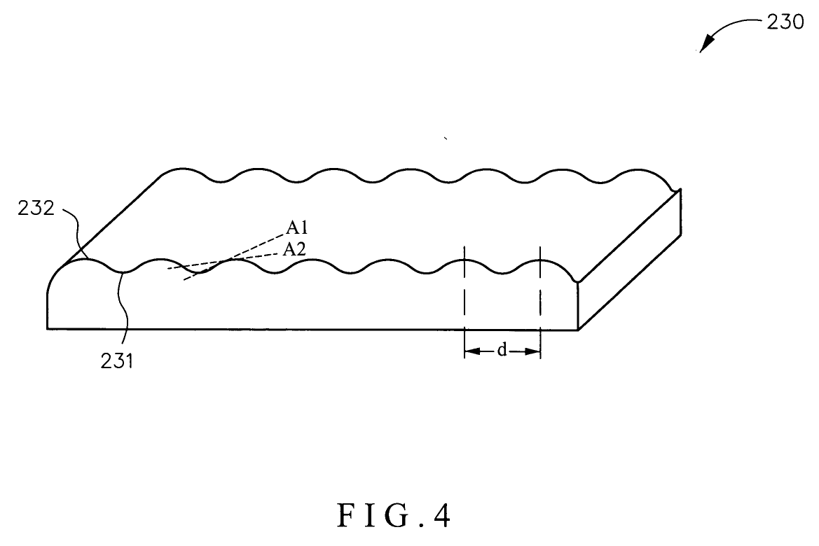

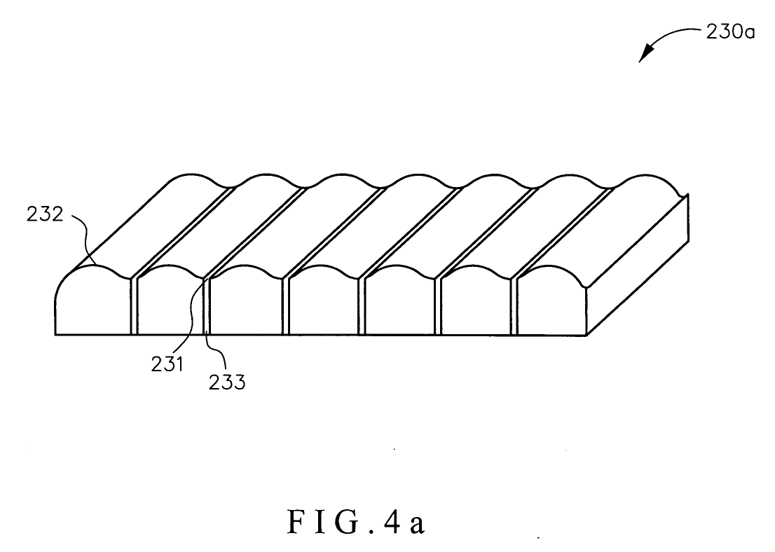

Please refer to FIG. 4, each of the grating structures 230 has a plurality of concave parts 231 and a plurality of protruding parts 232. Each of the concave parts 231 is disposed between the two neighboring protruding parts 232. The pitches d between two neighboring protruding parts 232 of the grating structure 230 are identical. The grating structure 230 is a reflective grating structure. The diffraction principle of the grating structure 230 is described as follows. The extending directions of the tangent planes A1 and A2 of the concave parts 231 and the protruding parts 232 respectively are different. Because the directions of the light beams reflected by the concave parts 231 and the protruding parts are different, the light beams may interfere with each other due to the optical path difference generated by the different reflection angles. Thus, the diffraction light beams are generated. As shown, the cross-section of each of the concave parts 231 and each of the protruding parts 232 shows an arc-shape. That is, the cross-section of the grating structure 230 may show a sine wave.

In another embodiment of the invention, the grating structures 230 may be transparent grating structures 230a as shown in FIG. 4a. As FIG. 4a shows, the concave parts 231 of the transparent grating structures 230a has slots 233. The diffraction principle of the penetrative grating structures 230a is described as follows. The light beams pass through the transparent grating structures 230a through the slots 233. The light beams passing through different slots 233 are interfere with each other, and thus the diffraction light beams are generated.

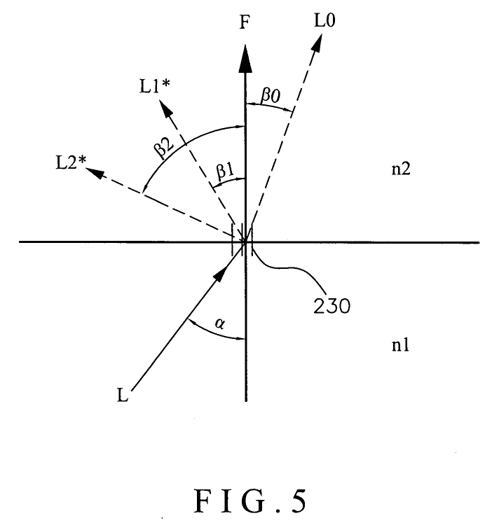

As shown in FIG. 5, after the light beams L entering the grating structures 230, the zero-order diffraction light beam L0, minus-first-order diffraction light beam L1*, minus-second-order diffraction light beam L2*, and the other order diffraction light beams Lm are generated. The diffraction light beams L0, L1* and L2* are corresponded to the diffraction angles β0, β1, and β2* respectively. The diffraction angle βm, which is corresponded to the diffraction light beam Lm, is relative to the pitch d of the grating structure 230, the wavelength of the incident light beam L, the refractive index of environment, and the refractive index of the grating structure 230 with a diffraction grating equation as shown below:

d(n2 sin(βm)−n1 sin(α))=mλ (1)

In above equation (1), n1 is the refractive index of the medium where the incident light beam L comes from, n2 is the refractive index of the medium where the diffraction light beams L0, L1*, and L2* locate, λ is the wavelength of the incident light beam L, α is the incident angle between the incident light beam L and the normal line F, βm indicates the diffraction angle between the diffraction light beam Lm and the normal line F respectively. Wherein, m is defined as the diffraction order, and m may be 0, ±1, ±2 . . . . The symbol with * indicates that the diffraction order is negative. For example, the diffraction light beam with the diffraction order m is equal to 1 is represented by L1, and the diffraction angle is β1; the diffraction light beam with the diffraction order m is equal to −1 is represented by L1*, and the diffraction angle is β1*.

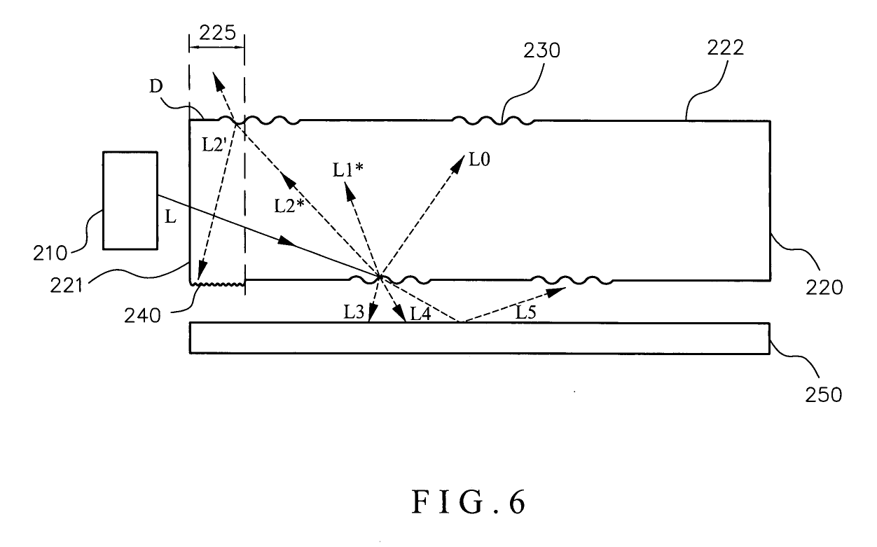

Referring to FIG. 6, the light beams L entering the light guide plate 220 through the light incident surface 221 pass through the grating structure 230 and the reflective diffraction light beams L0 to L2* and the transparent diffraction light beams L3 to L5 are generated. The reflective diffraction light beams L2* are adapted to compensate the illumination of the dark area 225, wherein a portion of the diffraction light beam L2* is refracted and emitted outward from the light emitting surface 222, and a portion of the diffraction light beam L2* is diffracted by the grating structures 230 disposed on the light emitting surface 222 to generate a diffraction light beam L2′. The diffraction light beam L2′ may be reflected back to the light guide plate 220 again. The transparent diffraction light beams L3 to L5 are reflected by the reflector 250 disposed under the bottom 223 of the light guide plate 220 and enters the light guide plate 220 again so as to enhance the uniformity of the emitted light of the light guide plate 220 and increase the using efficiency of light beams L emitting from the light guide plate 220.

In the embodiment, the ratio of the wavelength of the light beams emitted by the point light source 210 to the pitch d of the grating structure 230 is ranged between 1.2 to 1.3. Moreover, according to the equation (1), when the refractive index n1 of the incident medium and the refractive index n2 of the emergent medium are fixed, the pitch d of the grating structure 230 may be varied with the wavelength λ of the light beams L emitted by the different point light source 210 so as to control the diffraction angle βm of the diffraction light beam Lm with different wavelength λ to improve illumination uniformity of the emitting light of the light guide plate 220.

Referring to FIG. 3, the diffusion dots 240 are disposed on the bottom 223 of the light guide plate 220, adjacent to the light incident surface 221, and located between neighboring point light sources 210. The position of the diffusion dots 240 is also the dark area 225 as mentioned above. After the light beam L being dispersed by the grating structures 230, a portion of the diffraction light beam Lm is emitted to the area full of the diffusion dots 240 and scattered by the diffusion dots 240. The scattered light beam is then emitted outward from the light emitting surface 222 of the light guide plate 220 for decreasing the impact of the dark area 225 (a triangle prism space) of the light guide plate 220 on the uniformity of the emitting light of the backlight module 200. In an embodiment, the diffusion dots 240 are not limited to the region adjacent to the light incident surface 221 of the light guide plate 220. The diffusion dots 240 may be distributed on the whole bottom 223 and the light emitting surface 222 for improving the property of shading the defects of the backlight module 200 to make the brightness more uniform.

Referring to FIG. 2, the optical films include a diffuser 260, brightness enhancement films (BEF) 270 and 280. The diffuser 260, the BEFs 270 and 280 are sequentially stacked on the light emitting surface 222 of the light guide plate 220. The light beam from the light guide plate 220 is diffused by the diffuser 260 and emitted to the BEFs 270 and 280. The diffuser 260 is utilized to uniformize the emitting light of the backlight module 200. The BEFs 270 and 280 are capable of concentrating the light beams to increase the whole brightness of the backlight module 200.

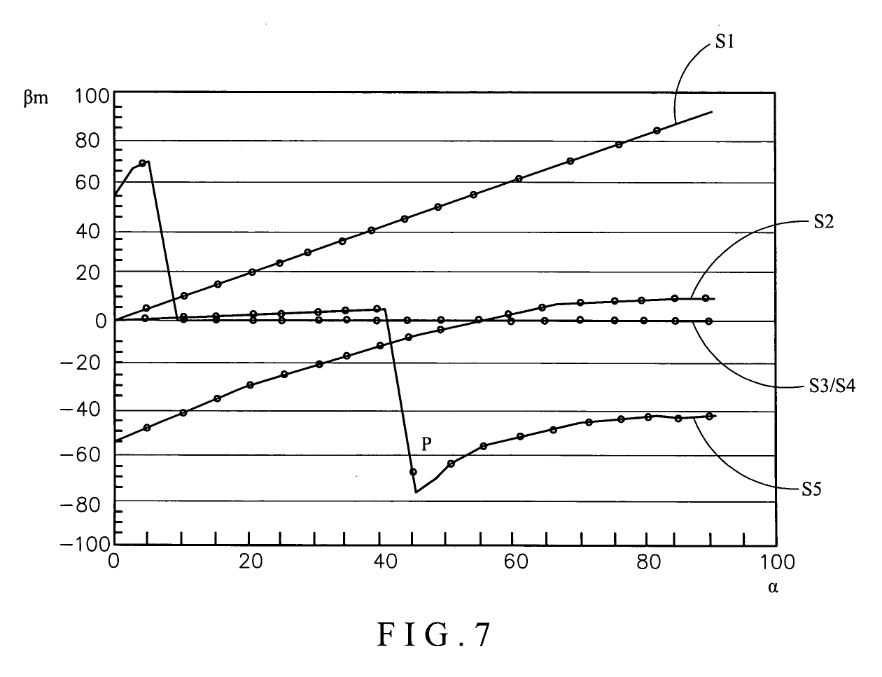

Also refer to FIG. 6 and FIG. 7, FIG. 7 is obtained according to the simulation result by using the equation (1). In FIG. 7, the vertical axis represents the diffraction angle βm, the horizontal axis represents the incident angle α, and the curves S1˜S5 show the change curves of the diffraction angles βm of the light beams with diffraction order 0, −1, 1, 2, and −2 according to different incident angles α respectively. The curve S1 shows the change curves of the diffraction angle β0 of the zero-order diffraction light beam according to different incident angles α. The curve S2 shows the change curves of the diffraction angle β1* of the minus-first-order diffraction light beam according to different incident angles α. The curve S3 shows the change curves of the diffraction angle β1 of the first-order diffraction light beam according to different incident angles α. The curve S4 shows the change curves of the diffraction angle β2 of the second-order diffraction light beam according to different incident angles α. The curve S5 shows the change curves of the diffraction angle β2* of the minus-second-order diffraction light beam according to different incident angles α.

As the curve S5 shows, the diffraction angle β2* of the minus-second-order diffraction light beam L2* varies significantly with the incident angle α. When the incident angle α is ranged from 40 degrees to 45 degrees, the diffraction angle β2* would be ranged from 5 degrees to −75 degrees. As the point P of FIG. 7 indicates, when the incident angle α of the light beam L is 45 degrees, the diffraction angle β2* of the minus-second-order diffraction light beam L2* is −75 degrees. That is, the 45 degrees incident light beam L is rotated with an angle of 120 degrees to form the −75 degrees diffraction light beam L2*. The beam L has a rotating angle of 120 degrees. Thus, the diffraction light beam L2* is able to reach the upper surface D of the dark area 225 for compensating the emitting light of the dark area 225.

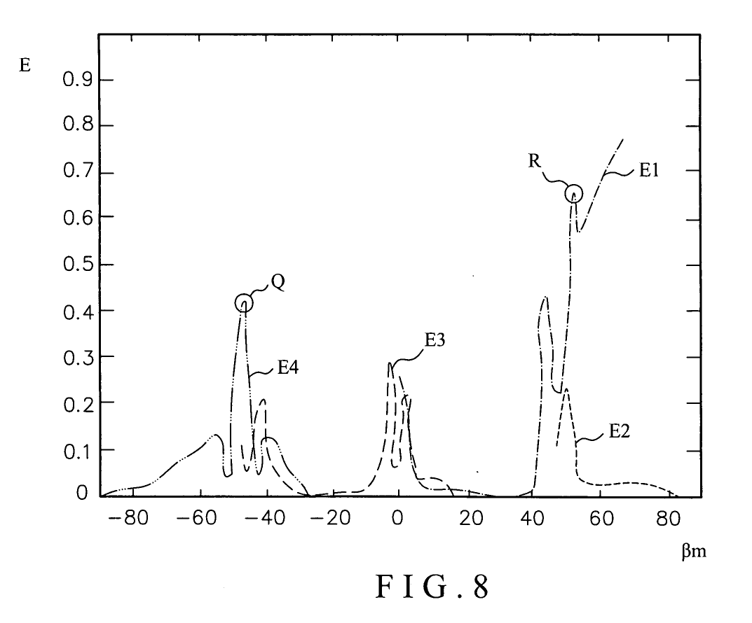

Moreover, refer to FIG. 8, the horizontal axis represents the diffraction angle βm, the vertical axis represents the energy E of the diffraction light beam Lm, and a grating structure 230 with the pitch d of 0.5 micron is used. The curves E1 to E4 show the change curves of the energy E of the zero, first, minus-first, and minus-second order diffraction light beams according to different diffraction angle βm respectively. The curve E1 shows the change curves of the energy E of the zero-order diffraction light beam according to different diffraction angle β0 thereof. The curve E2 shows the change curves of the energy E of the first-order diffraction light beam according to different diffraction angle β1 thereof. The curve E3 shows the change curves of the energy E of the minus-first-order diffraction light beam according to different diffraction angle β1* thereof. The curve E4 shows the change curves of the energy E of the minus-second-order diffraction light beam according to different diffraction angle β2* thereof.

In FIG. 8, the curve E1 is the energy curve with respect to the diffraction angle βm ranged between 50 degree to 70 degree, and the point R represents the largest energy of the zero-order diffraction light beam. However, referring to curve S1 in FIG. 7, for the incident angle α of the zero-order diffraction light beam L0 is substantially equal to the diffraction angle β0 thereof, so the zero-order diffraction light beam L0 has little deflection and may not be diffracted to the dark area 225 to compensate the emitting light of the dark area 225.

The curve E4 in FIG. 8 is the energy curve when the diffraction angle βm is about −50 degree, and the point Q represents the largest energy of the minus-second-order diffraction light beam L2*. Also referring to the curve S5 in FIG. 7, when the diffraction angle βm of the light beam L is about −50 degree, the incident angle α of the light beam L is about 45 degree, that is, the 45 degree incident light beam L is rotated with an angle of 95 degree to generate the −50 degree diffraction light beam L2*. Thus the minus-second-order diffraction light beam L2* may be diffracted back to the dark area 225 for compensating the emitting light of the dark area 225. In addition, the diffraction light beam L2* with the diffraction angle βm of about −50 degree has the largest energy, so the energy of the light beam L emitted from the light guide plate 220 is increased and the using efficiency of the light guide plate 220 is also increased.

In sum, the embodiment or embodiments of the invention may have at least one of the following advantages:

1. The pitch d of the grating structures 230 may be adjusted to control the diffraction direction of the diffraction light beam Lm with different wavelength λ so as to have the diffraction light beam Lm emitted to the dark area 225 to compensate the emitting light of the dark area 225 and increase the using efficiency of light beam L emitting from the light guide plate 220.

2. The diffusion dots 240 are disposed on the light guide plate 220 to reduce the impact of the dark area 225 to the uniformity of the emitting light of the backlight module 200 so as to improve the shading property for the defects of the backlight module 200 and make the brightness more uniform.

The foregoing description of the preferred embodiment of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like is not necessary limited the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A light guide plate, adapted to a backlight module with a plurality of point light sources capable of providing a light beam of a predetermined wavelength, the light guide plate comprising:
a bottom;
a light emitting surface, opposite to the bottom;
a light incident surface, being connected with the light emitting surface and the bottom, and near the point light sources;
a plurality of grating structures, each of the grating structures having a plurality of concave parts and a plurality of protruding parts, and each of the concave parts being disposed between the two neighboring protruding parts, and a ratio of the predetermined wavelength to a pitch between the two neighboring protruding parts being ranged between 1.2 to 1.3, wherein a portion of the grating structures are disposed on the light emitting surface; and
a plurality of diffusion dots, disposed on the bottom.

2. The light guide plate of claim 1, wherein a cross-section of the concave part or the protruding part shows an arc-shape.

3. The light guide plate of claim 1, wherein a portion of the grating structures are disposed on the bottom of the light guide plate.

4. The light guide plate of claim 1, wherein the grating structure is one of a transparent grating structure and a reflective grating structure.

5. The light guide plate of claim 1, wherein the diffusion dots are close to the light incident surface and are located between the point light sources.

6. A light guide plate, adapted to a backlight module with a plurality of point light sources capable of providing a light beam of a predetermined wavelength, the light guide plate comprising:
a bottom;
a light emitting surface, opposite to the bottom;
a light incident surface, being connected with the light emitting surface and the bottom, and near the point light sources;
a plurality of grating structures, each of the grating structures having a plurality of concave parts and a plurality of protruding parts, each of the concave parts being disposed between the two neighboring protruding parts, and a ratio of the predetermined wavelength to a pitch between the two neighboring protruding parts being ranged between 1.2 to 1.3, wherein a portion of the grating structures are disposed on the bottom; and
a plurality of diffusion dots, disposed on the bottom.

7. The light guide plate of claim 6, wherein a cross-section of the concave part or the protruding part shows an arc-shape.

8. The light guide plate of claim 6, wherein a portion of the grating structures are disposed on the light emitting surface of the light guide plate.

9. The light guide plate of claim 6, wherein the grating structure is one of a transparent grating structure and a reflective grating structure.

10. The light guide plate of claim 6, wherein the diffusion dots are disposed close to the light incident surface and are located between the point light sources.

11. A backlight module, comprising:
a plurality of point light sources, capable of providing a light beam of a predetermined wavelength; and
a light guide plate, comprising a light emitting surface, a bottom opposite to the light emitting surface, a light incident surface being connected with the light emitting surface and the bottom, a plurality of grating structures, and a plurality of diffusion dots, wherein the light incident surface is near the point light sources, the grating structures are disposed on the bottom and the light emitting surface, each of the grating structures has a plurality of concave parts and a plurality of protruding parts and each of the concave parts is disposed between the two neighboring protruding parts, a ratio of the predetermined wavelength to a pitch between the two neighboring protruding parts is ranged between 1.2 to 1.3, and the diffusion dots are disposed on the bottom.

12. The backlight module of claim 11, wherein a cross-section of the concave part or the protruding part shows an arc-shape.

13. The backlight module of claim 11, wherein the grating structure is one of a transparent grating structure and a reflective grating structure.

14. The backlight module of claim 11, wherein the diffusion dots are disposed close to the light incident surface and are located between the point light sources.

15. The backlight module of claim 11, further comprising a reflector disposed on the bottom of the light guide plate and a plurality of optical films disposed on the light emitting surface of the light guide plate.

16. The backlight module of claim 15, wherein the optical films comprise a diffusion plate and a brightness enhancement film.
